(19) United States
(12) Patent Application Publication
(10) Pub. No.: US 2015/0106582 A1
(43) Pub. Date: Apr. 16, 2015

(54) APPARATUS AND METHOD FOR MANAGING DATA IN HYBRID MEMORY

(71) Applicant: ELECTRONICS AND TELECOMMUNICATIONS RESEARCH INSTITUTE, Daejeon-city (KR)

(72) Inventors: Hai Thanh MAI, Daejeon (KR); Hunsoon LEE, Daejeon (KR); Kyounghyun PARK, Daejeon (KR); Changsoo KIM, Daejeon (KR); Miyoung LEE, Daejeon (KR)

(73) Assignee: ELECTRONICS AND TELECOMMUNICATIONS RESEARCH INSTITUTE, Daejeon-city (KR)

(21) Appl. No.: 14/464,981

(22) Filed: Aug. 21, 2014

(30) Foreign Application Priority Data
Oct. 14, 2013 (KR) 10-2013-0122119

(51) Int. Cl. G06F 3/06

(52) U.S. Cl. CPC G06F 3/0649; G06F 3/068; G06F 3/061
USPC 711/165

(57) ABSTRACT

An apparatus and method for managing data in hybrid memory are disclosed. The apparatus for managing data in hybrid memory may include a page access prediction unit, a candidate page classification unit, and a page placement determination unit. The page access prediction unit predicts an access frequency value for each page for a specific period in a future based on an access frequency history generated for the page. The candidate page classification unit classifies the page as a candidate page for migration based on the predicted access frequency value for the page. The page placement determination unit determines a placement option for the classified candidate page.

### CROSS REFERENCE TO RELATED APPLICATION

This application claims the benefit of Korean Patent Application No. 10-2013-0122119, filed Oct. 14, 2013, which is hereby incorporated by reference in its entirety into this application.

### BACKGROUND OF THE INVENTION

1. Technical Field

The present invention relates generally to an apparatus and method for managing data in hybrid memory and, more particularly, to technology that dynamically places data between a plurality of pieces of memory included in hybrid memory.

2. Description of the Related Art

Dynamic random access memory (DRAM) has been one of the most important components in the main memory of a computer system for several decades. Recently, as the amount of data requiring real-time processing rapidly increases, there is even higher need on DRAM for scaling up the performance and reducing the pressure on secondary storage devices. For example, beside keeping the indexes and temporary data, storing and processing the entire or large amounts of the data itself in DRAM has become an attractive approach for many commercial in-memory database management applications.

DRAM has a critical disadvantage in energy consumption despite its very high processing speed. The reason is that DRAM is volatile memory and thus always requires power in order to retain information stored therein. Energy efficiency is especially very important in systems having very high energy cost, such as data centers and database servers. Accordingly, in the storage and management of a large amount of data for a long term, it is very difficult to reduce the loss of energy while maintaining high performance of main memory.

Recently, in order to solve this problem, a hybrid memory system using both non-volatile RAM (NVRAM), that is, non-volatile memory, and DRAM, that is, volatile memory, has been introduced. NVRAM may include phase change RAM (PRAM), ferroelectric RAM (FRAM), magnetoresistive RAM (MRAM), and flash memory. NVRAM is more efficient in storing and managing large quantities of data over an extended period of time in terms of energy consumption and cost compared to DRAM because it does not need to consume energy in order to retain stored data. On the other hand, NVRAM is unable to fully replace DRAM because it is less effective than DRAM in terms of read and write speed. Accordingly, a hybrid memory system including both DRAM and NVRAM is highly preferred. In general, DRAM that is inefficient in terms of energy but has high processing speed occupies a relatively small portion (e.g., about 20%) of a hybrid memory system and NVRAM occupies the remaining portion of the hybrid memory system.

In recent hybrid memory systems, attempts are made to compensate for the disadvantages of DRAM and NVRAM by storing hot data having a relative high access frequency number in DRAM and cold data having a relatively low access frequency number in NVRAM by taking into consideration the access numbers based on each page (e.g., of 4 KB) of an operating system (OS).

However, in spite of such attempts, there is no significant achievement in improving the performance of a hybrid memory system because data is migrated simply based on the most recent access frequency or migration is determined without taking into consideration the characteristics of DRAM and various types of NVRAM.

### SUMMARY OF THE INVENTION

Accordingly, the present invention has been made keeping in mind the above problems occurring in the conventional art, and an object of the present invention is to provide an apparatus and method for managing data that are capable of efficiently managing data in memory by taking into consideration various pieces of information, such as data access frequency and migration gain and cost, in DRAM and NVRAM-based hybrid memory.

In accordance with an aspect of the present invention, there is provided an apparatus for managing data in hybrid memory, including a page access prediction unit configured to predict an access frequency value for each page for a specific period in a future based on an access frequency history generated for the page; a candidate page classification unit configured to classify the page as a candidate page for migration based on the predicted access frequency value for the page; and a page placement determination unit configured to determine a placement option for the classified candidate page.

The apparatus may further include a page access monitoring unit configured to monitor access to the page while the hybrid memory is being used, and to generate the access frequency history for the page.

The page access monitoring unit may monitor access to the page at specific time intervals, may calculate access frequency values for the page, and may generate the access frequency history based on the calculated access frequency values.

The page access prediction unit may predict the access frequency value for the specific period in the future using any one of a simple scheme, a statistical scheme, and a combination of the simple scheme and the statistical scheme based on the access frequency history.

The simple scheme may include predicting an access frequency value, calculated at a specific point of time predetermined in the access frequency history, as the access frequency value for the specific period in the future.

The statistical scheme may include linear regression analysis.

The combination of the simple scheme and the statistical scheme may include comparing an actual access frequency value with each of access frequency values predicted using two or more of a plurality of prediction schemes included in the simple scheme or the statistical scheme, and predicting the access frequency value for the specific period in the future using any one prediction scheme selected based on the results of the comparison.

The candidate page classification unit may classify the page as a hot candidate page if the predicted access frequency value for the page exceeds a specific threshold or as a cold candidate page if the predicted access frequency value for the page does not exceed the specific threshold.

The page placement determination unit may compute a migration benefit for the page classified as the candidate page, and may determine the placement option for the page based on the computed migration benefit.

The page placement determination unit may compute migration gain and cost by taking into consideration one or more of a response time and energy consumption of memory and the predicted access frequency value for the page, and may compute the migration benefit for the page based on the computed migration gain and cost.

The placement option may include maintaining the classified candidate pages in a current type of memory, and moving the classified candidate pages to another type of memory.

The apparatus may further include a page movement management unit configured to move a page having the determined placement option in which the page is moved to another type of memory based on the determined placement option.

In accordance with another aspect of the present invention, there is provided a method of managing data of hybrid memory, including predicting an access frequency value for each page for a specific period in a future based on an access frequency history generated for the page; classifying the page as a candidate page for migration based on the predicted access frequency value for the pages; and determining a placement option for the candidate page.

The method may further include monitoring access to the page while the hybrid memory is being used, and generating the access frequency history for the page.

Generating the access frequency history may include monitoring access to the page at specific time intervals; calculating access frequency values for the page; and generating the access frequency history based on the calculated access frequency values.

Classifying the pages as the candidate page may include comparing the predicted access frequency value for the page with a specific threshold; and classifying the page as a hot candidate page if the predicted access frequency value for the page exceeds the specific threshold or as a cold candidate page if the predicted access frequency value for the page does not exceed the specific threshold.

Determining the placement option may include computing a migration benefit for the page classified as the candidate page, and the placement option may be determined based on the computed migration benefit.

Determining the placement option may include computing migration gain and cost by taking into consideration one or more of a response time and energy consumption of the concerned type of memory and the predicted access frequency value for the page; and computing the migration benefit may include computing the migration benefit for the page based on the computed migration gain and cost.

The method may further include moving the page having the determined placement option in which the page is moved to another type of memory based on the determined placement option.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a hybrid memory system to which an apparatus for managing data in hybrid memory has been applied according to an embodiment of the present invention;

FIG. 2 is a block diagram illustrating an apparatus for managing data in hybrid memory according to an embodiment of the present invention;

FIG. 3 is a diagram illustrating the monitoring of access to a page according to an embodiment of the present invention;

FIG. 4 illustrates an example of an access frequency history generated according to an embodiment of the present invention;

FIG. 5 is a flowchart illustrating a method of managing data in hybrid memory according to an embodiment of the present invention;

FIG. 6 is a detailed flowchart illustrating a process of classifying a page as a candidate page in the method of managing data of FIG. 5 according to an embodiment of the present invention; and

FIG. 7 is a detailed flowchart illustrating a process of determining a placement option in the method of managing data of FIG. 5 according to an embodiment of the present invention.

### DESCRIPTION OF THE PREFERRED EMBODIMENTS

Reference now should be made to the drawings, throughout which the same reference numerals are used to designate the same or similar components.

Embodiments of an apparatus and method for managing data in hybrid memory are described in detail below with reference to the accompanying drawings.

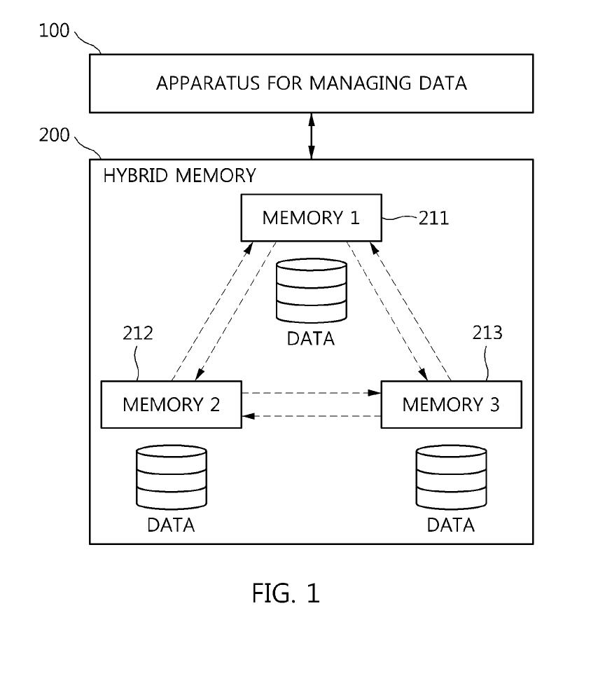

FIG. 1 is a block diagram illustrating a hybrid memory system to which an apparatus 100 for managing data in hybrid memory has been applied according to an embodiment of the present invention.

Referring to FIG. 1, the hybrid memory system may include the apparatus 100 for managing data and hybrid memory 200.

The hybrid memory 200 may include a plurality of pieces of memory 211, 212 and 213.

Although the hybrid memory 200 of FIG. 1 has been illustrated as including the three types of memory 211, 212 and 213 for ease of description, the types of memory included in the hybrid memory 200 are not limited.

Some of the plurality of pieces of memory 211, 212 and 213 included in the hybrid memory 200 may be dynamic random access memory (DRAM)-based memory, and the remainder may be non-volatile random access memory (NVRAM)-based memory.

In general, DRAM has fast response speed, but has high energy consumption. That is, DRAM, which is volatile memory, requires high power in order to retain stored information. In contrast, NVRAM, which is non-volatile memory, has relatively slow response speed, but it is more efficient in terms of energy consumption. Accordingly, in common hybrid memory systems, DRAM occupies a small portion (e.g., about 20%) of the entire memory, and NVRAM occupies the remaining portion.

The apparatus 100 for managing data according to this embodiment of the present invention may analyze the migration benefit of data, stored in the DRAM and NVRAM-based memory 211, 212 and 213 as described above, based on access frequency values, the types of memory 211, 212 and 213 and system conditions, and may determine in which of the pieces of memory the data need be placed in order to achieve optimum performance. Furthermore, the apparatus 100 for managing data may provide support so that response speed and energy consumption are satisfied at the same time by moving the data to the determined memory and appropriately placing the data based on the characteristics of each of the pieces of memory.

For example, the apparatus 100 for managing data may monitor an access frequency value for each page, may classify the page as a hot page or a cold page, and may move the page to appropriate memory based on the results of the analysis. In this case, the hot page may have a relatively high access frequency value, and may be a data page that puts processing speed before the prevention of energy consumption. The cold page may have a relatively low access frequency value, and may be a data page that puts the prevention of energy consumption before processing speed.

For example, if the memory 1 211 of the hybrid memory 200 is DRAM-based memory, the memory 2 212 and the memory 3 213 are NVRAM-based memory and the memory 2 212 has relatively faster response speed than the memory 3 213, the apparatus 100 for managing data may move a hot page stored in the memory 2 212 to the memory 1 211 having fast processing speed, and may move a hot page stored in the memory 3 213 to either the memory 1 211 or the memory 2 212 having more excellent performance. In contrast, the apparatus 100 for managing data may move a cold page stored in the memory 1 211 to either the memory 2 212 or the memory 3 213, and may move a cold page stored in the memory 2 212 to the memory 3 213.

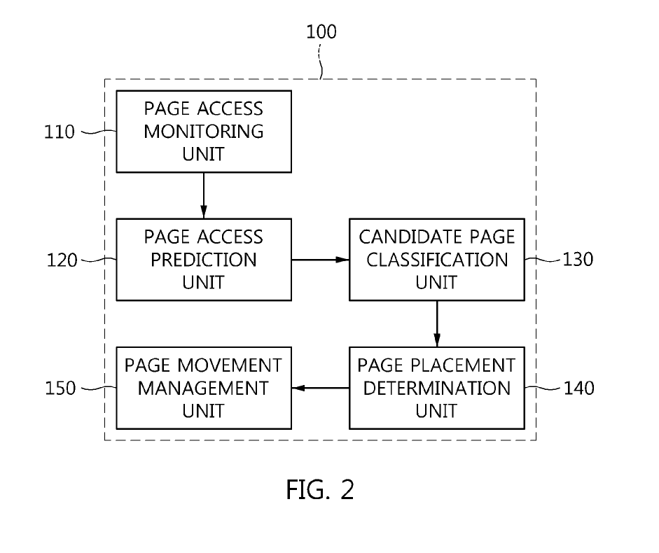

An apparatus 100 for managing data of the hybrid memory according to an embodiment of the present invention is described in detail below with reference to FIG. 2.

FIG. 2 is a block diagram illustrating the apparatus for managing data in hybrid memory according to this embodiment of the present invention.

Referring to FIG. 2, the apparatus 100 for managing data may include a page access monitoring unit 110, a page access prediction unit 120, a candidate page classification unit 130, a page placement determination unit 140, and a page movement management unit 150.

While hybrid memory is being used, the page access monitoring unit 110 monitors the access of various applications to data pages stored in the memory, that is, read and write operations, and calculates an access frequency value for each page. In this case, the access frequency value may be divided into a read access frequency value and a write access frequency value.

The page access prediction unit 120 may predict an access frequency value for each page for a specific period in the future based on the calculated access frequency value for each page. In this case, the page access prediction unit 120 may predict the access frequency value using various schemes, such as a simple scheme and a statistical scheme.

The simple scheme is a simple prediction method that is predetermined by a user. For example, in the simple scheme, an access frequency value that belongs to multiple access frequency values calculated at specific time intervals for a specific period in the past based on a current point of time and that has been calculated at a specific point of time (e.g., the most recent point of time) may be predicted as an access frequency value for a specific period in the future. Alternatively, various types of methods that are capable of relatively simply predicting the mean and intermediate value of an access frequency value for a specific period in the past may be used as the simple scheme.

The statistical scheme may include various types of mathematic schemes that are capable of relative precise prediction although they are complicated like linear regression analysis.

Furthermore, the page access prediction unit 120 may predict an access frequency value for a specific period in the future by using two or more of a plurality of prediction schemes included in the simple scheme or the statistical scheme in combination. For example, the page access prediction unit 120 may compare an actual access frequency value with predicted access frequency values calculated using the prediction schemes, may select a prediction scheme by which the most precise prediction value has been calculated, and may predict an access frequency value for a specific period in the future by using the selected prediction scheme.

An access frequency value prediction scheme is not limited to the aforementioned schemes, and an access frequency value may be predicted according to a user's chosen setting or using a variety of other methods.

As described above, an access frequency value for the case where each page will be accessed for a specific period in the future is predicted by taking into consideration an access frequency value for the case where the page has been accessed for a specific period in the past, based on a current point of time. Accordingly, the hybrid memory system may determine in which of DRAM and NVRAM each page need to be placed in order to achieve optimum performance.

When an access frequency value for a specific period in the future is predicted for each page as described above, the candidate page classification unit 130 classifies the page as a candidate page for migration based on the access frequency values. In this case, the candidate page may be classified as a hot candidate page that has a relatively large access frequency value and that requires high processing speed or a cold candidate page that has a relatively small access frequency value and that requires relatively low processing speed. However, the candidate page is not limited to the hot or cold candidate page, and the candidate page may be classified as one of n (where n is larger than 2) candidate pages based on various criteria, such as system conditions, the characteristics of each of the pieces of memory, and migration policies determined by a user.

The candidate page classification unit 130 may compare the predicted access frequency value for each page with a predetermined threshold, and may classify the page as the hot candidate page or the cold candidate page based on the results of the comparison. For example, the candidate page classification unit 130 may classify a page as the hot candidate page if the access frequency value for the page exceeds a predetermined threshold, and may classify the page as the cold candidate page if the access frequency value for the page does not exceed the predetermined threshold.

In this case, the threshold is a value predetermined by a user, and may be set in various ways depending on system conditions. For example, the predetermined threshold may be automatically controlled depending on a hardware state when a page is classified, or page may be classified as one of candidate pages using two or more thresholds having different values, as described above.

If the predicted access frequency value is divided into a read access frequency value and a write access frequency value, the candidate page classification unit 130 may use the sum of the read access frequency value and the write access frequency value. In this case, different weights may be assigned to the read access frequency value and the write access frequency value, and then the read access frequency value and the write access frequency value may be added. That is, overall processing speed and the level of satisfaction may be improved by assigning a higher weight to one of the read and write operations that requires faster processing.

The candidate page classification unit 130 may perform a candidate page classification task on all pages having predicted access frequency values, and may arrange a hot candidate page list and a cold candidate page list, generated after the classification task has been completed, in ascending order or in descending order based on the predicted access frequency values for the respective pages.

The page placement determination unit 140 may determine a placement option for each page classified as the hot candidate page or the cold candidate page. The placement options may include an option in which data stored in one type of memory remains therein and an option in which data stored in memory is moved to another type of memory. The option in which data stored in one type of memory is moved to another type of memory may include moving the data of DRAM to NVRAM (e.g., PRAM, MRAM or flash memory) and moving the data of NVRAM to DRAM or another NVRAM.

For example, if a page now stored in DRAM is classified as the hot candidate page, the placement option may be determined so that the page remains in the DRAM. In contrast, if the page is classified as the cold candidate page, the placement option may be determined so that the page is moved to NVRAM.

Furthermore, if a page now stored in NVRAM is classified as the hot candidate page, the placement option may be determined so that the page is moved to DRAM. In contrast, if the page now stored in NVRAM is classified as the cold candidate page, the placement option may be determined so that the page remains in the NVRAM or so that the page is moved to another NVRAM that has relatively slower response speed than the current NVRAM but is more advantageous than the current NVRAM in terms of energy consumption.

According to an additional aspect, the page placement determination unit 140 may calculate a migration benefit for each page, and may determine the placement option by taking into consideration the computed migration benefit. In this case, the page placement determination unit 140 may calculate migration gain and cost for each page by taking into consideration the response time and energy consumption of all pieces of memory included in the hybrid memory and the predicted access frequency value for each of pages stored in all the pieces of memory, and may use a value, obtained by subtracting the migration cost from the calculated migration gain, as a migration benefit.

If a specific page stored in DRAM has a migration benefit having a negative (−) value even when the specific page is classified as the cold candidate page to be moved to NVRAM, that is, if migration cost is higher than a migration benefit, the page placement determination unit 140 may determine the placement option so that the specific page remains in the DRAM. If one or more pieces of memory having a compute migration benefit having a positive (+) value are present, the page placement determination unit 140 may determine the placement option so that a specific page is moved to the type of memory having the highest migration benefit.

In this case, if it is determined that a specific type of memory has no remaining capacity when a data page is moved based on the determined placement option, the page placement determination unit 140 may exclude the specific type of memory from target memory to which the data page will be moved, and may determine the placement option by taking into consideration only the other type of memory.

As described above, according to the disclosed embodiment, a migration benefit is computed by taking into consideration the performance or characteristics of each of all pieces of memory included in the hybrid memory, and the computed migration benefit is used for the placement of data pages, thereby being capable of keeping the performance of the hybrid memory optimal.

When the page placement determination unit 140 determines the placement option for each page, the page movement management unit 150 moves the page, determined to be moved from the current type of memory to another type of memory, to the chosen other type of memory.

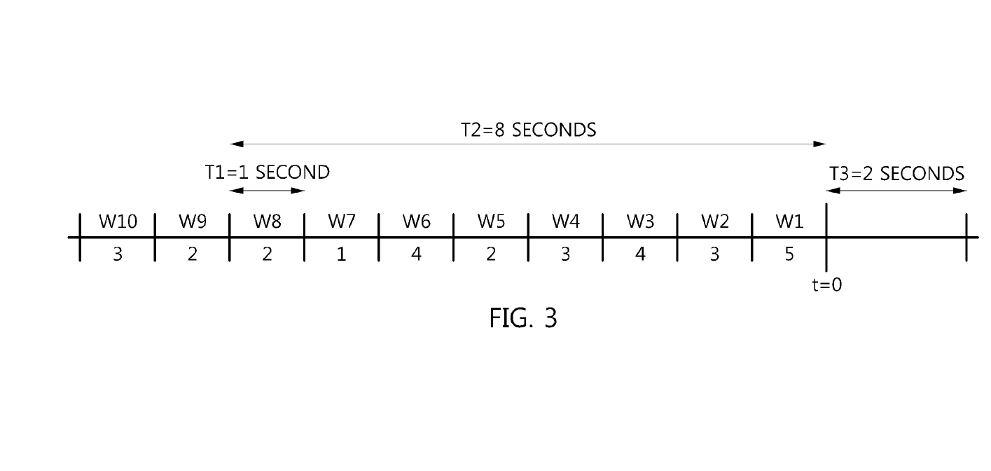

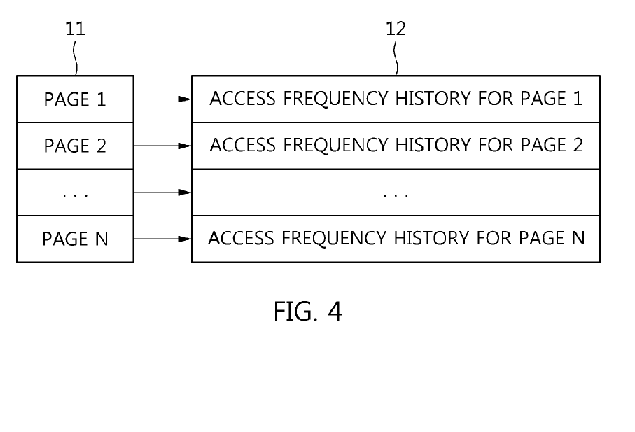

FIG. 3 is a diagram illustrating the monitoring of access to a page according to an embodiment of the present invention. FIG. 4 illustrates an example of an access frequency history generated according to an embodiment of the present invention.

An example of a process in which the apparatus 100 for managing data of monitors access to each page, calculates an access frequency value for the page, and predicts an access frequency value for a specific period in the future using the calculated access frequency value is described with reference to FIGS. 2 to 4.

As illustrated in FIG. 3, the page access monitoring unit 110 may monitor access to each page at specific time intervals T1, and may calculate access frequency values at the specific time intervals T1. The time interval T1 may be set to, for example, 1 second, 2 seconds, or 10 seconds, in various ways.

Assuming that a monitoring interval represented using a time interval T1 is considered to be a window for ease of description, if the specific time interval T1 is 1 second as illustrated in FIG. 3, the page access monitoring unit 110 may monitor access to windows W1 to W10 at the time intervals of 1 second, and may calculate the access frequency values for the windows W1 to W10. FIG. 3 illustrates access frequency values 5, 3, 4, 3, 2, 4, 1, 2, 2 and 3 sequentially calculated for the 10 windows W1 to W10.

The page access monitoring unit 110 may generate the access frequency history 12 of each page based on the access frequency values calculated by monitoring access for the windows W1 to W10. The access frequency history 12 may be classified into a read access frequency history and a write access frequency history. The access frequency history 12 may be generated in a list form and stored in a file format. The access frequency history 12 may be loaded onto main memory and used, if necessary. Alternatively, the access frequency history 12 may be stored in a database in the form of a table and used, if necessary.

The page access prediction unit 130 may predict an access frequency value for the case where each page will be accessed for a specific period T3 in the future, for example, 2 seconds in the future using the access frequency history 12 of the page that has been generated up to a current point of time t=0.

In this case, the page access prediction unit 130 may predict the access frequency value using a predetermined scheme as described above. For example, if the simple scheme in which an access frequency value most recently calculated based on the current point of time t=0 is used as a predicted access frequency value is previously predetermined, the page access prediction unit 130 may predict an access frequency value of 5, calculated for the most recent window W1, as an access frequency value for 2 seconds in the future.

According to an additional aspect, as illustrated in FIG. 3, the page access prediction unit 130 may predict an access frequency value using an access frequency history for a specific period T2 in the past, for example, 8 seconds in the past based on the current point of time t=0. The reason for this is to prevent any delay of the prediction time that may occur if the amount of collected access frequency history data is excessively large. An optimum analysis period T2 may be set through a pre-processing process by taking into consideration various conditions, such as system performance.

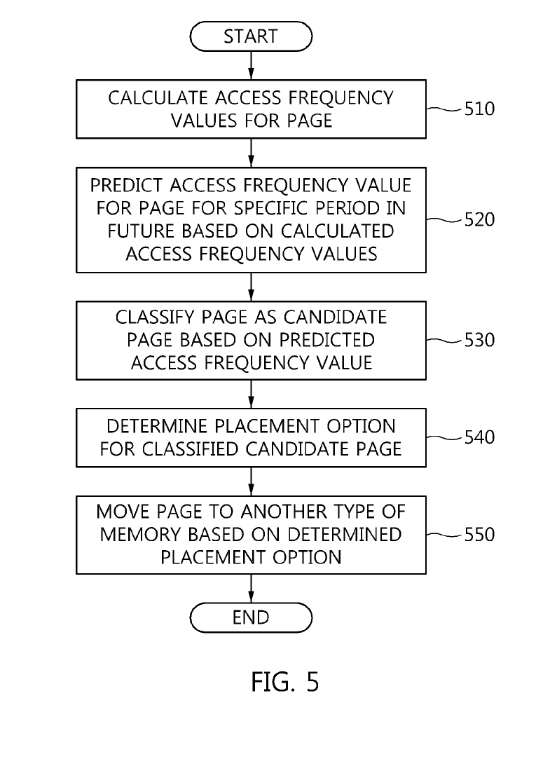

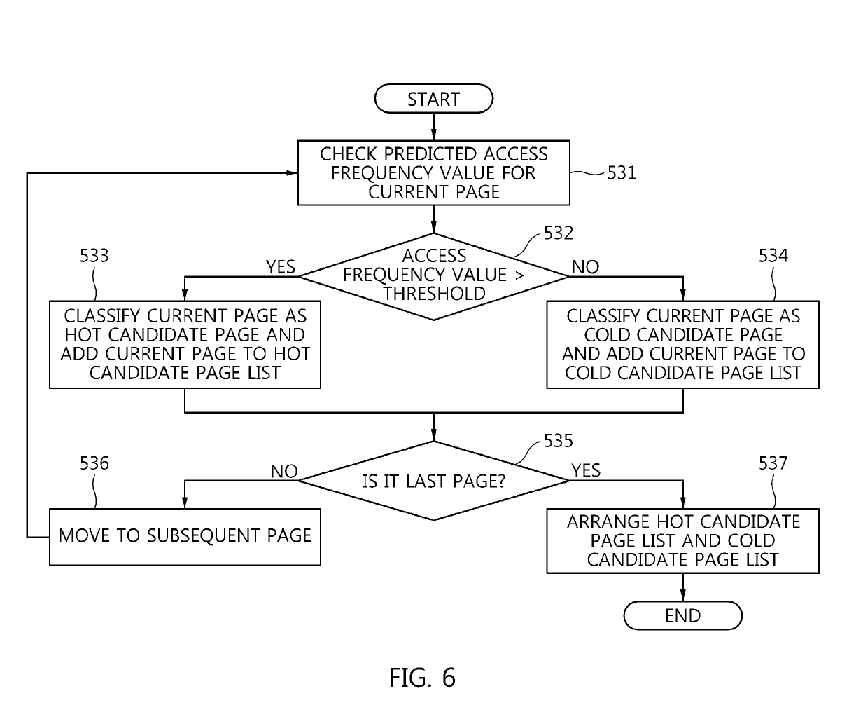

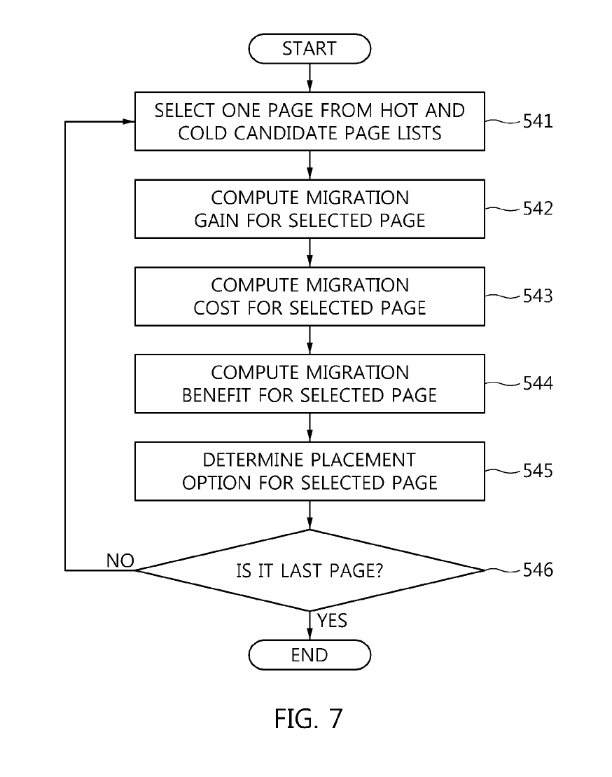

FIG. 5 is a flowchart illustrating a method of managing data in the hybrid memory according to an embodiment of the present invention. FIG. 6 is a detailed flowchart illustrating a process of classifying a page as a candidate page in the method of managing data of FIG. 5 according to an embodiment of the present invention. FIG. 7 is a detailed flowchart illustrating a process of determining a placement option in the method of managing data of FIG. 5 according to an embodiment of the present invention.

The method and processes of FIGS. 5 to 7 may be performed by the apparatus 100 for managing data of the hybrid memory of FIG. 2 according to the embodiment of the present invention. The method of managing data performed by the apparatus 100 for managing data of the hybrid memory has been described in detail above and thus is described in brief below.

First, the apparatus 100 for managing data monitors access to data pages stored in the pieces of memory while the hybrid memory is being used, and calculates access frequency values for each page at step 510.

In this case, the apparatus 100 for managing data may monitor access to each page at specific time intervals based on a current point of time, and may calculate the access frequency values for the page. Furthermore, the apparatus 100 for managing data may generate an access frequency history for the page based on the calculated access frequency values.

The access frequency values may be classified into read access frequency values, that is, frequency values for read operations, and write access frequency values, that is, frequency values for write operations.

Thereafter, the apparatus 100 for managing data may predict an access frequency value for each page for a specific period in the future based on the calculated access frequency values at step 520. As described above, the apparatus 100 for managing data may predict the access frequency value using a variety of predetermined access schemes, that is, a simple scheme and a statistical scheme. In this case, in order to prevent a delay of prediction time, the apparatus 100 for managing data may predict the access frequency value using access history data for a predetermined period.

After the access frequency value for each page for a specific period in the future has been predicted, the apparatus 100 for managing data may classify the page as a candidate page for migration based on the predicted access frequency value at step 530. In this case, the page may be classified as a hot candidate page requiring faster processing and a cold candidate page requiring slower processing.

Classifying a page as a candidate page at step 530 is described in more detail below with reference to FIG. 6.

First, the apparatus 100 for managing data checks an access frequency value predicted for a current page at step 531.

The apparatus 100 for managing data compares the predicted access frequency value with a predetermined threshold at step 532. If, as a result of the comparison, the predicted access frequency value is found to exceed the threshold, the apparatus 100 for managing data classifies the current page as the hot candidate page and adds the current page to a hot candidate page list at step 533.

If, as a result of the comparison at step 532, the predicted access frequency value is found not to exceed the threshold, the apparatus 100 for managing data classifies the current page as the cold candidate page and adds the current page to a cold candidate page list at step 534.

In this case, if the predicted access frequency value is predicted as read and write access frequency values, a higher weight may be assigned to a predicted access frequency value corresponding to one of read and write operations requiring faster processing, and then the sum of the predicted access frequency values may be compared with the threshold.

Thereafter, the apparatus 100 for managing data may check whether or not the current page is the last page at step 535. If, as a result of the determination, it is determined that the current page is not the last page, the apparatus 100 for managing data may move on to a subsequent page at step 536, and may return to step 531.

If, as a result of the determination at step 535, it is determined that the current page is the last page, the apparatus 100 for managing data may arrange the hot candidate page list and the cold candidate page list based on the predicted access frequency values at step 537.

Referring back to FIG. 5, the apparatus 100 for managing data may determine a placement option for each page classified as the hot candidate pages or the cold candidate pages at step 540. In this case, the placement option may including maintaining a current page stored in memory or moving the current page to another memory.

Step 540 of determining the placement option is described in more detail below with reference to FIG. 7. First, the apparatus 100 for managing data selects one page between the hot candidate page and the cold candidate page which are received sequentially from the hot candidate page list and the cold candidate page list, respectively, at step 541. For example, the apparatus 100 chooses pages in a round-robin fashion, giving equal chances for hot and cold pages to be migrated.

The apparatus 100 for managing data computes the migration gain for the selected page at step 542 and then computes the migration cost for the selected page at step 543. The migration gain and cost are computed for all the pieces of memory included in the hybrid memory, and may be computed by taking into consideration the response speed and energy consumption of each of the pieces of memory.

Thereafter, the apparatus 100 for managing data computes the migration benefit for the selected page based on the calculated migration gain and cost for the selected page at step 544. In this case, the migration benefit may be a value obtained by subtracting the migration cost from the migration gain.

Thereafter, the apparatus 100 for managing data determines the placement option for the selected page at step 545. For example, if the computed migration benefits for all the pieces of memory have negative values, the apparatus 100 for managing data may determine the placement option in which current pages remain therein regardless of the types of classified candidate pages. In contrast, if one or more pieces of memory having a migration benefit having a positive value are present, the apparatus 100 for managing data may determine the placement option in which a current is moved to memory having the greatest migration benefit.

Thereafter, the apparatus 100 for managing data checks whether or not the selected page is the last page at step 546. If, as a result of the determination, it is determined that the current page is not the last page, the apparatus 100 for managing data returns to step 541. If, as a result of the determination at step 546, it is determined that the current page is the last page, the apparatus 100 for managing data terminates the process.

Referring back to FIG. 5, when the placement option for each of all the pages is determined at step 540, the apparatus 100 for managing data moves pages, determined to be moved from current memory to another type of memory, to another type of memory at step 550.

As described above, data is disposed between pieces of memory by taking into consideration various conditions, such as the access frequency value, migration gain and migration cost in hybrid DRAM-based memory and NVRAM. Accordingly, efficiency can be improved in terms of the response time and energy consumption.

Furthermore, data is managed and placed by taking into consideration various types of NVRAM included in hybrid memory, thereby being capable of achieving optimum system performance regardless of the type of NVRAM.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for managing data in hybrid memory, comprising:
a page access prediction unit configured to predict an access frequency value for each page for a specific period in a future based on an access frequency history generated for the page;
a candidate page classification unit configured to classify the page as a candidate page for migration based on the predicted access frequency value for the page; and
a page placement determination unit configured to determine a placement option for the classified candidate page.

2. The apparatus of claim 1, further comprising a page access monitoring unit configured to monitor access to the page while the hybrid memory is being used, and to generate the access frequency history for the page.

3. The apparatus of claim 2, wherein the page access monitoring unit monitors access to the page at specific time intervals, calculates access frequency values for the page, and generates the access frequency history based on the calculated access frequency values.

4. The apparatus of claim 1, wherein the page access prediction unit predicts the access frequency value for the specific period in the future using any one of a simple scheme, a statistical scheme, and a combination of the simple scheme and the statistical scheme based on the access frequency history.

5. The apparatus of claim 4, wherein the simple scheme comprises predicting an access frequency value, calculated at a specific point of time predetermined in the access frequency history, as the access frequency value for the specific period in the future.

6. The apparatus of claim 4, wherein the statistical scheme comprises linear regression analysis.

7. The apparatus of claim 4, wherein the combination of the simple scheme and the statistical scheme comprises comparing an actual access frequency value with each of access frequency values predicted using two or more of a plurality of prediction schemes included in the simple scheme or the statistical scheme, and predicting the access frequency value for the specific period in the future using any one prediction scheme selected based on the results of the comparison.

8. The apparatus of claim 1, wherein the candidate page classification unit classifies the page as a hot candidate page if the predicted access frequency value for the page exceeds a specific threshold, or as a cold candidate page if the predicted access frequency value for the page does not exceed the specific threshold.

9. The apparatus of claim 1, wherein the page placement determination unit computes a migration benefit for the page classified as the candidate page, and determines the placement option for the page based on the computed migration benefit.

10. The apparatus of claim 9, wherein the page placement determination unit computes migration gain and cost by taking into consideration one or more of a response time and energy consumption of memory and the predicted access frequency value for the page, and computes the migration benefit for the page based on the computed migration gain and cost.

11. The apparatus of claim 1, wherein the placement option comprises maintaining the classified candidate pages in the current type of memory, and moving the classified candidate pages to another type of memory.

12. The apparatus of claim 1, further comprising a page movement management unit configured to move a page having the determined placement option in which the page is moved to another type of memory based on the determined placement option.

13. A method of managing data of hybrid memory, comprising:
predicting an access frequency value for each page for a specific period in a future based on an access frequency history generated for the page;
classifying the page as a candidate page for migration based on the predicted access frequency value for the pages; and
determining a placement option for the candidate page.

14. The method of claim 13, further comprising monitoring access to the page while the hybrid memory is being used, and generating the access frequency history for the page.

15. The method of claim 14, wherein generating the access frequency history comprises:
monitoring access to the page at specific time intervals;
calculating access frequency values for the page; and
generating the access frequency history based on the calculated access frequency values.

16. The method of claim 13, wherein classifying the pages as the candidate page comprises:
comparing the predicted access frequency value for the page with a specific threshold; and
classifying the page as a hot candidate page if the predicted access frequency value for the page exceeds the specific threshold or as a cold candidate page if the predicted access frequency value for the page does not exceed the specific threshold.

17. The method of claim 13, wherein determining the placement option comprises computing a migration benefit for the page classified as the candidate page, and the placement option is determined based on the computed migration benefit.

18. The method of claim 17, wherein:
determining the placement option comprises computing migration gain and cost by taking into consideration one or more of a response time and energy consumption of the concerned type of memory and the predicted access frequency value for the page; and
computing the migration benefit comprises computing the migration benefit for the page based on the computed migration gain and cost.

19. The method of claim 13, further comprising moving the page having the determined placement option in which the page is moved to another type of memory based on the determined placement option.
